(19) United States
(12) Patent Application Publication
(10) Pub. No.: US 2026/0118848 A1
(43) Pub. Date: Apr. 30, 2026

(54) Method, Apparatus, Electronic Device, And Storage Medium For Marking An Operating Parameter

(71) Applicant: Siemens Aktiengesellschaft, München (DE)

(72) Inventors: Ming Yu, Wuhan (CN); Qi Wang, Hubei (CN); Yue Hua Zhang, Wuhan (CN); De Yu Tian, Wuhan (CN)

(73) Assignee: Siemens Aktiengesellschaft, München (DE)

(21) Appl. No.: 19/146,823

(22) PCT Filed: Jan. 13, 2023
(86) PCT No.: PCT/CN2023/072191

§ 371 Date: Jul. 9, 2025

(51) Int. Cl. G05B 19/406; G06T 7/20; G06V 10/62; G06V 10/82; G06V 20/64

(52) U.S. Cl. CPC G05B 19/406; G06T 7/20; G06V 10/62; G06V 10/82; G06V 20/64; G06V 2201/06

(57) ABSTRACT

Teachings of the present disclosure include methods, apparatus, electronic devices, and medium for marking an operating parameter. An example method includes: acquiring a three-dimensional image sequence of a spindle motion process of a machine tool, the three-dimensional image sequence captured by an imaging component; creating an operating parameter curve representing the spindle motion process; recognizing a spindle motion mode from the three-dimensional image sequence; determining time information of the spindle motion mode; and marking the operating parameter curve based on the time information and motion description information associated with the spindle motion mode.

### CROSS-REFERENCE TO RELATED APPLICATIONS

This application is a U.S. National Stage Application of International Application No. PCT/CN2023/072191 filed Jan. 13, 2023, which designates the United States of America, the contents of which are hereby incorporated by reference in their entirety.

### TECHNICAL FIELD

The present disclosure relates to data processing. Various embodiments of the teachings herein include methods, apparatus, electronic devices, and media for marking an operating parameter.

### BACKGROUND

With rapid development of digital techniques, a large amount of data is collected for the aiming of process simulation, optimization, and deep analysis to improve production efficiency. One of major challenges is to map production data to real processes, and then explain process details to data analysis experts or production applications to show the value behind the data.

Machine tool refers to a machine that makes machines. Machine tools include lathes, boring machines, milling machines, planers, grinders, and other types. A lathe is a machine tool that mainly uses turning tools to turn rotating workpieces. On the lathe, drills, reamers, taps, dies and knurling tools can also be used for corresponding processing. Lathes are mainly used to process shafts, discs, sleeves, and other workpieces with rotary surfaces. They are widely used in machinery manufacturing and repair plants.

At present, how to mark an operating parameter of a machine tool so that users can understand the meaning of the operating parameter is a technical problem to be solved.

### SUMMARY

Teachings of the present disclosure include methods, apparatus, electronic devices, and media for marking an operating parameter. For example, some embodiments of the teachings herein include a method for marking an operating parameter, comprising: acquiring (101) a three-dimensional image sequence about a spindle motion process of a machine tool, wherein the three-dimensional image sequence is captured by an imaging component; acquiring (102) an operating parameter curve about the spindle motion process; recognizing (103) a spindle motion mode from the three-dimensional image sequence; determining (104) time information of the spindle motion mode; and marking (105) the operating parameter curve based on the time information and motion description information associated with the spindle motion mode.

In some embodiments, recognizing (103) a spindle motion mode from the three-dimensional image sequence comprises: inputting the three-dimensional image sequence into a trained motion mode recognition model, wherein the motion mode recognition model is adapted to recognize the spindle motion mode in an artificial intelligence manner; and receiving the spindle motion mode output from the motion mode recognition model.

In some embodiments, recognizing (103) a spindle motion mode from the three-dimensional image sequence comprises recognizing the spindle motion mode from the three-dimensional image sequence through computer vision.

In some embodiments, the time information comprises a starting time point and an ending time point of the spindle motion mode.

In some embodiments, marking (105) the operating parameter curve based on the time information and motion description information associated with the spindle motion mode comprises: determining a first time point corresponding to the starting time point in the operating parameter curve; determining a second time point corresponding to the ending time point in the operating parameter curve; determining motion description information associated with the spindle motion mode; and marking the motion description information in the operating parameter curve within a time interval composed of the first time point and the second time point.

In some embodiments, the operating parameter curve comprises at least one of the following: vibration signal curve of spindle; power signal curve of spindle motor; temperature signal curve of spindle motor; power signal curve of servo motor; and temperature signal curve of servo motor.

In some embodiments, the spindle motion mode comprises at least one of the following: up-down motion; down-up motion; right-left motion; left-right motion; back-front motion; and front-back motion.

As another example, some embodiments include an apparatus for marking an operating parameter, comprising: a first acquiring module (601), configured to acquire a three-dimensional image sequence about a spindle motion process of a machine tool, wherein the three-dimensional image sequence is captured by an imaging component; a second acquiring module (602), configured to acquire an operating parameter curve about the spindle motion process; a recognizing module (603), configured to recognize a spindle motion mode from the three-dimensional image sequence; a determining module (604), configured to determine time information of the spindle motion mode; and a marking module (605), configured to mark the operating parameter curve based on the time information and motion description information associated with the spindle motion mode.

In some the recognizing module (603) embodiments, is configured to input the three-dimensional image sequence into a trained motion mode recognition model, wherein the motion mode recognition model is adapted to recognize the spindle motion mode in an artificial intelligence manner; and to receive the spindle motion mode output from the motion mode recognition model.

In some embodiments, the recognizing module (603) is configured to recognize the spindle motion mode from the three-dimensional image sequence through computer vision.

In some embodiments, the time information comprises a starting time point and an ending time point of the spindle motion mode.

In some embodiments, the marking module (605) is configured to determine a first time point corresponding to the starting time point in the operating parameter curve; determine a second time point corresponding to the ending time point in the operating parameter curve; determine motion description information associated with the spindle motion mode; and to mark the motion description information in the operating parameter curve within a time interval composed of the first time point and the second time point.

As another example, some embodiments include an electronic device comprising a processor (701) and a memory (702), wherein an application program executable by the processor (701) is stored in the memory (702) for causing the processor (701) to execute one or more of the methods for marking an operating parameter as described herein.

As another example, some embodiments include a computer-readable medium comprising computer-readable instructions stored thereon, wherein the computer-readable instructions for executing one or more of the methods for marking an operating parameter described herein.

As another example, some embodiments include a computer program product comprising a computer program, upon the computer program is executed by a processor for executing one or more of the methods for marking an operating parameter described herein.

### BRIEF DESCRIPTION OF THE DRAWINGS

In order to make the teachings of the present disclosure clearer, accompanying drawings are used in the description of the examples hereinafter. Obviously, the accompanying drawings to be described hereinafter are only some examples of the teachings of the present disclosure. Those skilled in the art may obtain other drawings according to these accompanying drawings without creative labor. In the figures:

FIG. 1 is a flowchart of an example method for marking an operating parameter incorporating teachings of the present disclosure;

FIG. 2 is a schematic diagram of an example system architecture for marking an operating parameter incorporating teachings of the present disclosure;

FIG. 3 is a schematic diagram of an example process for marking an operating parameter incorporating teachings of the present disclosure;

FIG. 4 is a schematic diagram of a spindle motion mode incorporating teachings of the present disclosure;

FIG. 5 is a schematic diagram of a marked spindle vibration signal curve incorporating teachings of the present disclosure;

FIG. 6 is a block diagram of an example apparatus for marking an operating parameter incorporating teachings of the present disclosure; and

FIG. 7 is a structural diagram of an example electronic device incorporating teachings of the present disclosure.

### LIST OF REFERENCE NUMBERS

| reference | |
|---|---|
| numbers | meanings |
| 100 | method for marking an operating parameter |
| 101~105 | steps |
| 21 | imaging component |
| 22 | server |
| 23 | cloud |
| 24 | machine tool |
| 30 | real-time sensor data |
| 31 | model configuration process |
| 32 | cloud |
| 33 | motion mode recognition process |
| 34 | motion mode database |
| 35 | marking process |
| 36 | machine tool design data |
| 37 | camera data |
| 61 | first time interval |
| 62 | second time interval |
| 600 | apparatus for marking an operating parameter |
| 601 | first acquiring module |
| 602 | second acquiring module |
| 603 | recognizing module |
| 604 | determining module |
| 605 | marking module |
| 700 | electronic device |
| 701 | processor |
| 702 | memory |

### DETAILED DESCRIPTION

Some embodiments of the teachings herein include a method for marking an operating parameter comprising: acquiring a three-dimensional image sequence about a spindle motion process of a machine tool, wherein the three-dimensional image sequence is captured by an imaging component; acquiring an operating parameter curve about the spindle motion process; recognizing a spindle motion mode from the three-dimensional image sequence; determining time information of the spindle motion mode; and marking the operating parameter curve based on the time information and motion description information associated with the spindle motion mode. Motion description information is marked in the operating parameter curve to facilitate the understanding of the operating parameter.

In some embodiments, recognizing a spindle motion mode from the three-dimensional image sequence comprises: putting the three-dimensional image sequence into a trained motion mode recognition model, wherein the motion mode recognition model is adapted to recognize the spindle motion mode in an artificial intelligence manner; and receiving the spindle motion mode output from the motion mode recognition model. Recognition efficiency can be improved by introducing artificial intelligence into motion mode recognition process of machine tools.

In some embodiments, recognizing a spindle motion mode from the three-dimensional image sequence comprises recognizing the spindle motion mode from the three-dimensional image sequence through computer vision. The spindle motion mode of machine tool can be easily recognized through computer vision.

In some embodiments, the time information comprises a starting time point and an ending time point of the spindle motion mode. The starting time point and ending time point of the spindle motion mode are introduced into the marking process to facilitate user's understanding of the operating parameter.

In some embodiments, marking the operating parameter curve based on the time information and motion description information associated with the spindle motion mode comprises: determining a first time point corresponding to the starting time point in the operating parameter curve; determining a second time point corresponding to the ending time point in the operating parameter curve; determining motion description information associated with the spindle motion mode; and marking the motion description information in the operating parameter curve within a time interval composed of the first time point and the second time point. By marking motion description information in a time interval composed of the first time point and the second time point, users can understand the operating parameter in both time dimension and spindle motion dimension, which improves the comprehensiveness of understanding.

In some embodiments, the operating parameter curve comprises at least one of the following: vibration signal curve of spindle; power signal curve of spindle motor; temperature signal curve of spindle motor; power signal curve of servo motor; and temperature signal curve of servo motor. The operating parameter curve has wide applicability.

In some embodiments, the spindle motion mode comprises at least one of the following: up-down motion; down-up motion; right-left motion; left-right motion; back-front motion; and front-back motion. The spindle motion mode has wide applicability.

Some embodiments include an apparatus for marking an operating parameter comprising: a first acquiring module, configured to acquire a three-dimensional image sequence about a spindle motion process of a machine tool, wherein the three-dimensional image sequence is captured by an imaging component; a second acquiring module, configured to acquire an operating parameter curve about the spindle motion process; a recognizing module, configured to recognize a spindle motion mode from the three-dimensional image sequence; a determining module, configured to determine time information of the spindle motion mode; and a marking module, configured to mark the operating parameter curve based on the time information and motion description information associated with the spindle motion mode. Motion description information is marked in the operating parameter curve to facilitate the understanding of the operating parameter.

In some embodiments, the recognizing module is configured to put the three-dimensional image sequence into a trained motion mode recognition model, wherein the motion mode recognition model is adapted to recognize the spindle motion mode in an artificial intelligence manner; and to receive the spindle motion mode output from the motion mode recognition model. Recognition efficiency can be improved by introducing artificial intelligence into the motion mode recognition process of machine tools.

In some embodiments, the recognizing module is configured to recognize the spindle motion mode from the three-dimensional image sequence through computer vision. The spindle motion mode of machine tool can be easily recognized through computer vision.

In some embodiments, the time information comprises a starting time point and an ending time point of the spindle motion mode. The starting time point and the ending time point of the spindle motion mode are introduced into the marking process to facilitate user's understanding of the operating parameter.

In some embodiments, the marking module is configured to determine a first time point corresponding to the starting time point in the operating parameter curve; determine a second time point corresponding to the ending time point in the operating parameter curve; determine motion description information associated with the spindle motion mode; and to mark the motion description information in the operating parameter curve within a time interval composed of the first time point and the second time point. By marking motion description information in the time interval composed of the first time point and the second time point, users can understand the operating parameter in both time dimension and spindle motion dimension, which improves the comprehensiveness of understanding.

Some embodiments include an electronic device with a processor and a memory, wherein an application program executable by the processor is stored in the memory for causing the processor to execute one or more of the methods for marking an operating parameter as described herein.

Some embodiments include a non-transitory computer-readable medium comprising computer-readable instructions stored thereon, wherein the computer-readable instructions cause a processor to execute a method marking an operating parameter as described herein.

Some embodiments include a computer program product comprising a computer program, upon execution of the computer program a processor executes a method for marking an operating parameter as described herein.

In order to make the purpose, technical scheme, and potential advantages of the teachings of the present disclosure more clear, the following examples are given to further explain in detail. In order to be concise and intuitive in description, the scheme of is described below by describing several representative embodiments. Many details in the embodiments are only used to help understand the scheme. However, it is obvious that the technical scheme can be realized without being limited to these details. In order to avoid unnecessarily blurring the scheme, some embodiments are not described in detail, but only the framework is given. Hereinafter, “including” refers to “including but not limited to”, “according to . . . ” refers to “at least according to . . . , but not limited to . . . ”. Due to the language habits of Chinese, when the number of an element is not specifically indicated below, it means that the element can be one or more, or can be understood as at least one.

After research, the applicant found that a significant challenge for machine tool data analysis is that in many data analysis scenarios, there is a need to understand every motion of machine tool spindle. However, at present, many types of machine tools (such as outdated machine tools) cannot obtain motion status of every motion of the spindle from control logic program. Specifically, for some outdated machine tools, due to their long operation time, they either lack the data interaction interface of motion control logic or even cannot find a control logic program. Moreover, because upgrading and reconstruction cannot damage original control logic, external monitoring devices must be added to some outdated machine tools to obtain motion status of every motion of the spindle. After understanding and identifying motion control logic, operating parameters can be marked. For example, in the scenario of collecting machine tool operating parameters to predict spindle failure, for many outdated computer numerical control (CNC) machine tools, only program ID of machine tool can be collected at present. A program usually contains multiple subprograms, but the subprogram used to control each motion of the spindle has no ID, so it is impossible to obtain motion status of each motion of the spindle from the control logic program, thus it is difficult to accurately mark each motion of the spindle in operating parameter curve.

The applicant also found that the data could be manually marked in operating parameter curve t to solve the problem. However, the disadvantage of this method is that it is inefficient and heavily depends on the experience of engineers. A novel method is herein proposed to solve this problem. By combining motion mode recognition algorithm with operating parameters of automation system, operating parameters can be accurately marked, which expands application field and reduces complexity.

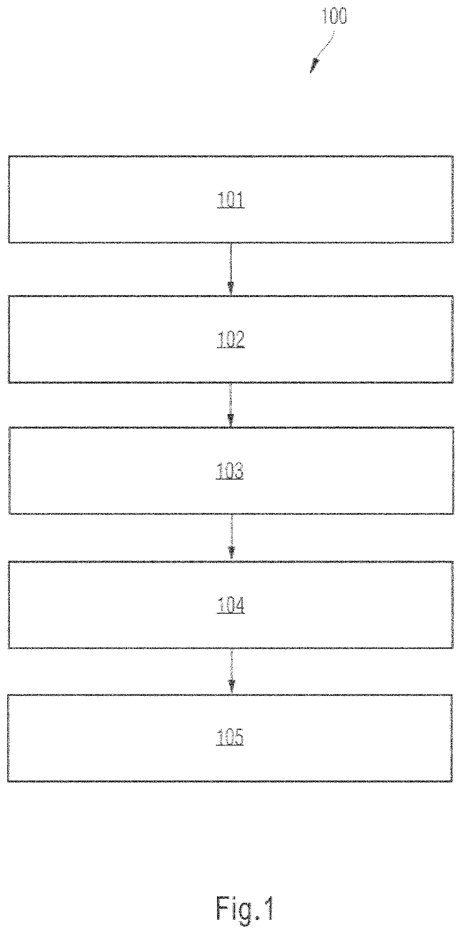

FIG. 1 is a flowchart of an example method for marking an operating parameter incorporating teachings of the present disclosure. As shown in FIG. 1, the method 100 comprises:
Step 101: acquiring a three-dimensional (3D) image sequence about a spindle motion process of a machine tool, wherein the 3D image sequence is captured by an imaging component. In some embodiments, the machine tool in step 101 is implemented as a machine tool that cannot obtain motion state of each motion of spindle from control logic program of the machine tool. The machine tool can include:
(1) Ordinary machine tools: including ordinary lathes, drilling machines, boring machines, milling machines, planning machines, and slotting machines, etc.
(2) Precision machine tools: including grinding machines, gear processing machines, thread processing machines and other precision machine tools.
(3) High precision machine tools: including coordinate boring machines, gear grinders, thread grinders, high-precision marking machines, high-precision marking machines and other high-precision machine tools.
(4). Numerical control machine tool (CNC).

In some embodiments, the machine tool can be implemented as a CNC machine tool. In general, the spindle of CNC machine tools is a hollow stepped shaft, specifically the shaft that drives chuck clamp (workpiece) or tool to rotate on the CNC lathe. It usually consists of spindle body, bearings, and transmission parts (gears or pulleys). During CNC machine tool processing, the spindle drives the workpiece or tool to directly participate in surface forming motion.

The above exemplary description of typical examples of machine tools will enable those skilled in the art to realize that this description is only exemplary and is not intended to limit the protection scope of the present disclosure.

The spindle motion process may include at least one motion mode. For example, the spindle motion process includes: the spindle moves from top to bottom at first and then moves from bottom to top. In another example, the spindle motion process can include: the spindle moves from right to left and then moves from left to right, and so on.

In some embodiments, the imaging component can be used to photograph the machine tool spindle to obtain a 3D image sequence about the motion process of the machine tool spindle. In another embodiment, the 3D image sequence can be obtained from a storage medium (such as a cloud or a local database), wherein the 3D image sequence is obtained by photographing the machine tool spindle with an imaging component. For example, the 3D image sequence includes multiple 3D images that are captured based on time sequence and run through the motion process of the machine tool spindle. Preferably, the 3D image sequence is real-time data.

In some embodiments, the imaging component includes at least one 3D camera. The 3D camera uses 3D imaging technology to photograph the machine tool spindle to generate a 3D image sequence about motion process of the machine tool spindle.

In some embodiments, the imaging component includes at least two 2D (two-dimensional) cameras, each of which is arranged at a predetermined position around the machine tool spindle. In practice, those skilled in the art can select a suitable position as a predetermined position to arrange the 2D cameras according to needs. The imaging component may further include an image processor. The image processor combines the 2D image sequences taken by each 2D camera into 3D image sequences in time synchronization. The depth of field information used by the image processor in the synthesis can be the depth of field information of any 2D image sequence. In some embodiments, each 2D camera can send the 2D image sequence captured by itself to an image processor outside the imaging component, so that the 2D image sequences captured by the 2D cameras can be synchronously combined into a 3D image sequence by an image processor outside the imaging component, wherein the depth of field information used by the image processor outside the imaging component in the synthesis process can also be the depth of field information of any 2D image.

In some embodiments, the imaging component may include at least one 2D camera and at least one depth of field sensor. Both the at least one 2D camera and at least one depth of field sensor are installed at a same position around spindle of the machine tool. The imaging component may further include an image processor. The image processor uses the depth of field information provided by the depth sensor and at least one 2D image sequence provided by at least one 2D camera to jointly generate a 3D image sequence. In some embodiments, at least one 2D camera sends at least one captured 2D image sequence to an image processor outside the imaging component, and the depth of field sensor sends collected depth of field information to an image processor outside the imaging component, so that the image processor outside the imaging component can use the depth of field information and at least one 2D image sequence to jointly generate a 3D image sequence.

After acquiring the 3D image sequence, the imaging component can send the 3D image sequence to the controller or server executing the process in FIG. 1 via a wired interface or a wireless interface. In some embodiments, the wired interface includes at least one of the following: a universal serial bus interface, a controller area network interface, a serial port, and the like; The wireless interface includes at least one of the following: infrared interface, near-field communication interface, Bluetooth interface, purple bee interface, wireless broadband interface, etc.
Step 102: acquiring an operating parameter curve about the spindle motion process. The operating parameter curve is a curve of an operating parameter of the machine tool during the spindle motion process. In some embodiments, the operation parameter curve includes at least one of the following: vibration signal curve of spindle; power signal curve of spindle motor; temperature signal curve of spindle motor; power signal curve of servo motor; temperature signal curve of servo motor, etc.

For example, the controller or server executing the process in FIG. 1 can obtain operating parameter curves from controller of the machine tool (such as CNC machine tool controller), or from SCADA system or sensors of the machine tool. Preferably, operating parameter curve is a real-time curve about a real-time operating parameter.

The above exemplary description of typical examples of operating parameter curve can be realized by those skilled in the art that this description is only exemplary and is not used to limit the protection scope of the present disclosure.
Step 103: recognizing a spindle motion mode from the 3D image sequence. The spindle motion mode is a preset. In some embodiments, the spindle motion mode includes at least one of the following: up-down motion; down-up motion; right-left motion; left-right motion; back-front motion; front-back motion.

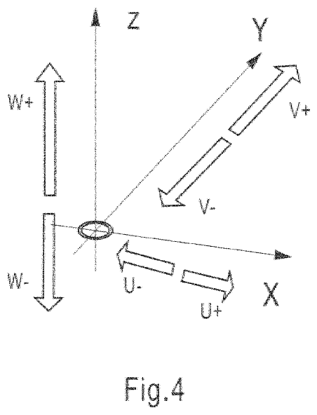

FIG. 4 is a schematic diagram of an example spindle motion mode as described herein. In a motion coordinate system of spindle shown in FIG. 4, it is specified that motion of the Z-axis is determined by spindle transmitting cutting power, and the coordinate axis parallel to the spindle axis is the Z-axis. The X-axis is horizontal, parallel to workpiece clamping surface and perpendicular to the Z-axis. Moreover, it is usually specified that the direction of tool away from workpiece is positive direction of coordinate axis. Therefore, the spindle motion modes include:
(1). Motion modes in the Z-axis direction, specifically including up-down motion (W−) and down-up motion (W+);
(2) Motion modes in the X-axis direction, specifically including left-right motion (U+) and right-left motion (U−);
(3) Motion modes in the Y-axis direction, specifically including back-front motion (V+) and front-back motion (V−).

In some embodiments, recognizing a spindle motion mode from the 3D image sequence comprises: putting the three-dimensional image sequence into a trained motion mode recognition model, wherein the motion mode recognition model is adapted to recognize the spindle motion mode in an artificial intelligence manner; receiving the spindle motion mode output from the motion mode recognition model. Here, the 3D image sequence is input into a trained motion mode recognition model to output a detection result for the 3D image sequence from the motion mode recognition model, where the detection result includes motion mode(s) of the spindle motion process.

Some embodiments include a training process of the motion mode recognition model. The training process includes: acquiring training data, which includes 3D image sequences (usually historical data) marked with spindle motion modes respectively; the training data is used to train a preset neural network model. When accuracy of output result of the neural network model is greater than a predetermined threshold, the training process of the motion mode recognition model is completed. Specifically, the neural network model can be implemented as: feedforward neural network model, radial basis function neural network model, long and short-term memory (LSTM) network model, echo state network (ESN), gate loop unit (GRU) network model or deep residual network model, etc. Recognition efficiency can be improved by introducing artificial intelligence into motion mode recognition process of machine tools.

In some embodiments, recognizing a spindle motion mode from the 3D image sequence comprises recognizing the spindle motion mode from the 3D image sequence through computer vision manner. In the computer vision mode: firstly, a spindle motion mode set containing a plurality of predetermined spindle motion modes is generated. Then, traditional feature extraction method of computer vision is used to extract image features from 3D image sequence, the image features extracted from 3D image sequence are compared with the image features of each spindle motion mode in the spindle motion mode set, and the spindle motion mode with the image features closest to the image features extracted from 3D image sequence is determined as the recognized spindle motion mode. The motion mode of the machine tool can be easily identified through computer vision.

In some embodiments, traditional feature extraction methods of computer vision include: scale invariant feature transform (SIFT) feature extraction method; Histogram of Orientated Gradient (HOG) feature extraction method; Accelerated Up Robust Features (SURF) extraction method; Oriented FAST and Rotated BRIEF (ORB) feature extraction method; Local binary patterns (LBP) feature extraction methods, etc. Accordingly, the image features extracted from the 3D image sequence include at least one of the following: SIFT feature; HOG characteristics; SURF characteristics; ORB characteristics; LBP characteristics, etc.
Step 104: determining time information of the spindle motion mode. Here, time information is related to time attributes of the recognized spindle motion mode. In some embodiments, the time information includes a starting time point and an ending time point of the spindle motion mode. Therefore, starting time point and ending time point of the spindle motion mode are introduced into marking processing to facilitate users to understand the operating parameter. In some embodiments, the time information may also include duration time of the spindle motion mode.

In some embodiments, the time information of the spindle motion mode is determined based on shooting time points included in the 3D image sequence. For example, a starting image frame and ending image frame of the spindle motion mode are determined from the 3D image sequence, and shooting time stored in the starting image frame is determined as starting time point of the spindle motion mode, and shooting time stored in the ending image frame is determined as ending time point of the spindle motion mode.
Step 105: marking the operating parameter curve based on the time information and motion description information associated with the spindle motion mode. Here, association between the spindle motion modes s and respective motion description information can be established in advance. For example, when spindle motion mode is an up-down motion, the corresponding motion description information can be “from up to down” in text format; When spindle motion mode is down-up motion, the corresponding motion description information can be “from down to up” in text format.

In some embodiments, marking the operating parameter curve based on the time information and motion description information associated with the spindle motion mode comprises: determining a first time point corresponding to the starting time point in the operating parameter curve; determining a second time point corresponding to the ending time point in the operating parameter curve; determining motion description information associated with the spindle motion mode; and marking the motion description information in the operating parameter curve within a time interval composed of the first time point and the second time point. Specifically, in the coordinate axis of the operating parameter curve, the horizontal axis is usually acquisition time of the parameter, and the vertical axis is usually the parameter value. A first time point having the same time as the starting time point and a second time point having the same time as the ending time point are determined in the horizontal axis. Then, in the operating parameter curve, in a time interval consisting of the first time point and the second time point, motion description information associated with the spindle motion mode is marked. Generally, the operating parameter curve can contain multiple spindle motion modes, and each spindle motion mode is marked with its own motion description information in the time dimension, so that users can understand operating parameter easily. By marking motion description information in the time interval composed of the first time point and the second time point, users can understand the operating parameter in both time dimension and spindle motion dimension, which improves the comprehensiveness of understanding.

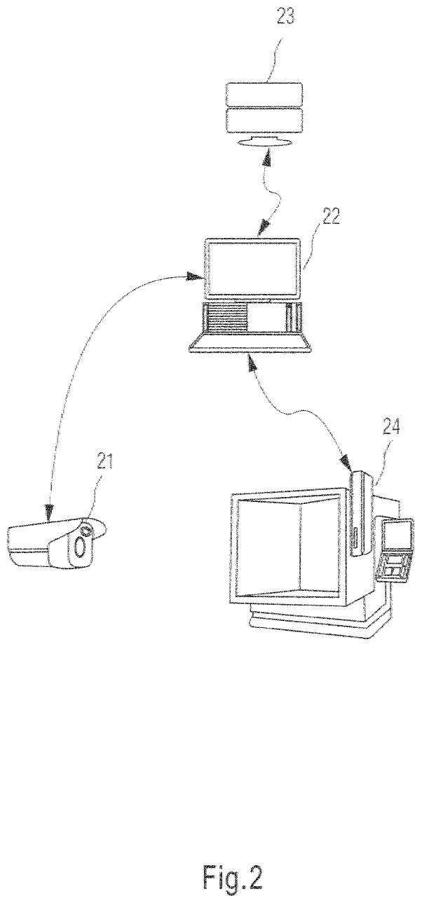

FIG. 2 is a schematic diagram of an example system architecture for marking an operating parameter incorporating teachings of the present disclosure. In FIG. 2, imaging component 21 is arranged at a peripheral position of machine tool 24. The imaging component 21 continuously collects a 3D image sequence of spindle motion process of machine tool 24. Furthermore, the imaging component 21 transmits the 3D image sequence to server 22. Server 22 obtains operating parameter curve in association with the motion process from sensors of the machine tool 24. Server 22 acquires predefined spindle motion modes and respective motion description information associated with the spindle motion modes from cloud 23. Server 22 recognizes a spindle motion mode from the 3D image sequence, and determines time information of the recognized spindle motion mode and motion description information associated with the spindle motion mode. Server 22 marks the operating parameter curve based on time information and motion description information.

For example, suppose that predefined spindle motion modes acquired by server 22 from cloud 23 include: up-down motion; down-up motion; right-left motion; left-right motion; back-front motion; front-back motion. Server 22 acquires a spindle vibration signal curve from machine tool 24. Server 22 acquires a 3D image sequence from imaging component 21. Spindle vibration signal curve is synchronized with 3D image sequence in time.

For example, server 22 recognizes an up-down motion from the 3D image sequence. The starting time point of the up-down motion is the first second, and the ending time point of the up-down motion is the third second. Then, server 22 continues to recognize a left-right motion from the 3D image sequence. The starting time point of the left-right motion is the third second, and the ending time point of the left-right motion is the sixth second. Therefore, server 22 marks “motion from up to down” between the first second and the third second of the spindle vibration signal curve, and “motion from left to right” between the third second and the sixth second of the spindle vibration signal curve.

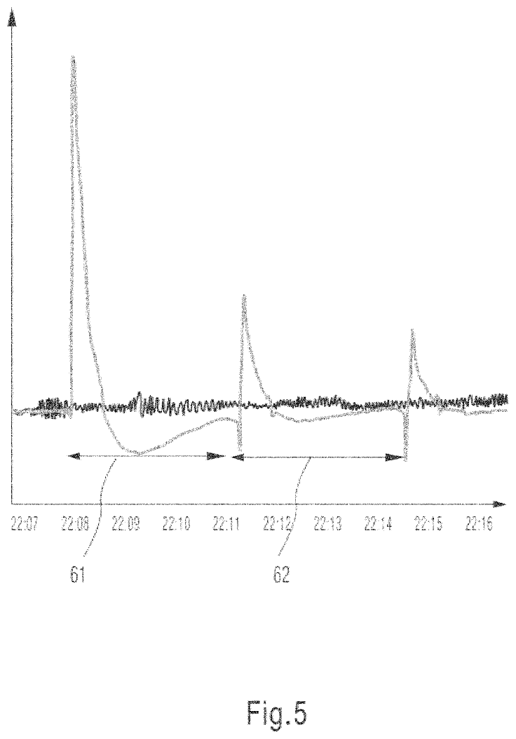

FIG. 5 is a schematic diagram of an example marked spindle vibration signal curve as described herein. In FIG. 5, the abscissa is time and the ordinate is vibration amplitude of spindle. The first time interval 61 is marked with “motion from up to down”, and the second time interval 62 is marked with “motion from left to right”.

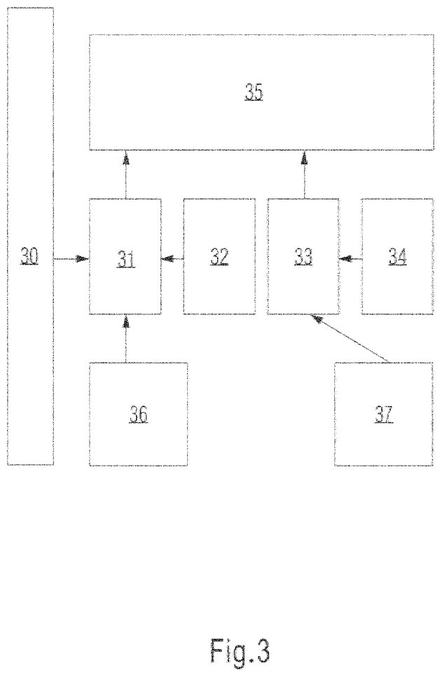

FIG. 3 is a schematic diagram of an example process for marking an operating parameter incorporating teachings of the present disclosure. In FIG. 3, camera data 37 (that is, 3D image sequence captured by imaging component with respect to spindle motion process of machine tool) is provided to motion mode recognition process 33, in which the camera data 37 is associated with identification information of the machine tool. The motion mode recognition process 33 acquires predetermined motion modes from motion mode database 34. The motion mode recognition process 33 includes a trained motion mode recognition model. The motion mode recognition model is trained based on the motion modes provided by the motion mode database 34. The motion mode recognition model recognizes a motion mode from the camera data 37, and determines a starting time point and an ending time point of the motion mode. The motion mode recognition process 33 provides the recognized motion mode and its motion description information, the starting time point, the ending time point, and identification information associated with the machine tool to marking process 35.

A sensor (such as spindle vibration sensor) detects real-time data during the spindle motion process of the machine tool to obtain real-time sensor data 30. Real-time sensor data 30 is provided to model configuration process 31. The model configuration process 31 obtains identification information of the machine tool from cloud 32. The model configuration process 31 retrieves an operating parameter corresponding to the sensor from the machine tool design data 36, and the retrieval result is the spindle vibration signal, thus determining that the real-time sensor data 30 is spindle vibration signal. The model configuration process 31 associates and stores identification information with the real-time sensor data 30, and provides the associated data to marking processing 35.

The marking process 35 compares identification information sent by motion mode recognition process 33 with identification information sent by model configuration process 31. After confirming the consistency, the marking process 35 determines a first time point corresponding to the starting time point and a second time point corresponding to the ending time point in the real-time sensor data 30, and marks motion description information of the recognized motion mode between the first time point and the second time point in the operating parameter curve.

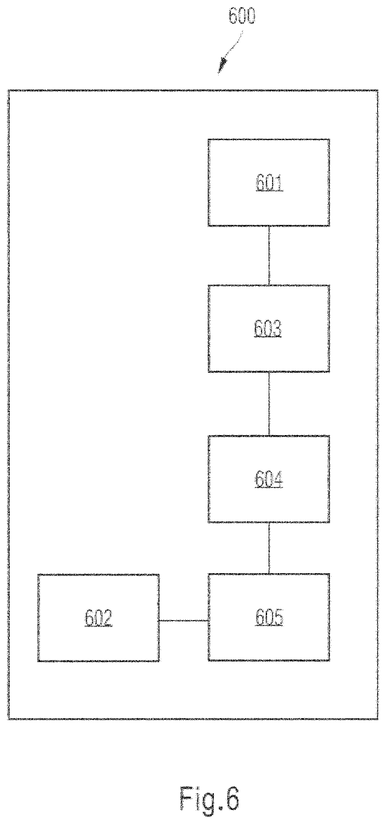

FIG. 6 is a block diagram of an example apparatus for marking an operating parameter incorporating teachings f the present disclosure. As shown in FIG. 6, the apparatus 600 comprises:
a first acquiring module 601, configured to acquire a three-dimensional image sequence about a spindle motion process of a machine tool, wherein the three-dimensional image sequence is captured by an imaging component; a second acquiring module 602, configured to acquire an operating parameter curve about the spindle motion process; a recognizing module 603, configured to recognize a spindle motion mode from the three-dimensional image sequence; a determining module 604, configured to determine time information of the spindle motion mode; and a marking module 605, configured to mark the operating parameter curve based on the time information and motion description information associated with the spindle motion mode.

In some embodiments, the recognizing module 603 is configured to input the three-dimensional image sequence into a trained motion mode recognition model, wherein the motion mode recognition model is adapted to recognize the spindle motion mode in an artificial intelligence manner; and to receive the spindle motion mode output from the motion mode recognition model.

In some embodiments, the recognizing module 603 is configured to recognize the spindle motion mode from the three-dimensional image sequence through computer vision.

In some embodiments, the time information comprises a starting time point and an ending time point of the spindle motion mode.

In some embodiments, the marking module 605 is configured to determine a first time point corresponding to the starting time point in the operating parameter curve; determine a second time point corresponding to the ending time point in the operating parameter curve; determine motion description information associated with the spindle motion mode; and to mark the motion description information in the operating parameter curve within a time interval composed of the first time point and the second time point.

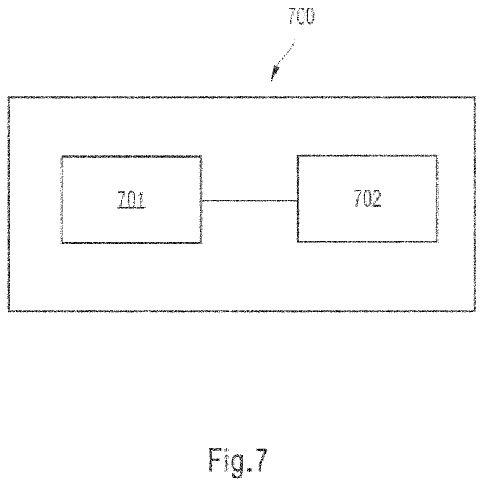

Some embodiments include an electronic device with a processor memory architecture. FIG. 7 is a structural diagram of an example electronic device incorporating teachings of the present disclosure. As shown in FIG. 7, electronic device 700 comprises processor 701, memory 702, and computer program stored on the memory 702 and capable of running on the processor 701. When the computer program is executed by the processor 701, the method for marking an operating parameter as described above is implemented. The memory 702 can be specifically implemented as a variety of storage media, such as EEPROM, Flash memory, PROM, etc. The processor 701 may be implemented to include one or more central processors or one or more field programmable gate arrays, wherein the field programmable gate arrays integrate one or more central processor cores. Specifically, the CPU or CPU core can be implemented as a CPU, MCU or DSP, and so on.

Not all steps and modules in the above processes and structure diagrams are necessary, and some steps or modules can be ignored according to actual needs. The execution sequence of each step is not fixed and can be adjusted as required. The division of each module is only for the convenience of describing the functional division adopted. In actual implementation, a module can be divided into multiple modules, and the functions of multiple modules can also be realized by the same module. These modules can be in the same device or in different devices.

The hardware modules in any embodiment may be implemented mechanically or electronically. For example, a hardware module can include a specially designed permanent circuit or logic device (such as a special processor, such as FPGA or ASIC) to complete a specific operation. Hardware modules may also include programmable logic devices or circuits temporarily configured by software, such as including general-purpose processors or other programmable processors, for performing specific operations. As for the specific implementation of hardware modules by mechanical means, or by special permanent circuits, or by temporarily configured circuits (such as those configured by software), it can be determined according to the consideration of cost and time.

The above descriptions are merely example embodiments of the present disclosure and are not intended to limit the protection scope thereof. Any modification, equivalent replacement, improvement, etc. made within the spirit and principle of the present disclosure shall be included within the protection scope thereof.

What is claimed is:

1. A method for marking an operating parameter, the method comprising:
acquiring a three-dimensional image sequence of a spindle motion process of a machine tool, the three-dimensional image sequence captured by an imaging component;
creating an operating parameter curve representing the spindle motion process;
recognizing a spindle motion mode from the three-dimensional image sequence;
determining time information of the spindle motion mode; and
marking the operating parameter curve based on the time information and motion description information associated with the spindle motion mode.

2. The method according to claim 1, wherein recognizing a spindle motion mode from the three-dimensional image sequence comprises:
putting the three-dimensional image sequence into a trained motion mode recognition model trained to recognize the spindle motion mode using artificial intelligence; and
receiving the spindle motion mode output from the motion mode recognition model.

3. The method according to claim 1, wherein recognizing a spindle motion mode from the three-dimensional image sequence comprises
recognizing the spindle motion mode from the three-dimensional image sequence using computer vision.

4. The method according to claim 1, wherein the time information comprises a starting time point and an ending time point of the spindle motion mode.

5. The method according to claim 1, wherein marking the operating parameter curve based on the time information and motion description information associated with the spindle motion mode comprises:
determining a first time point corresponding to the starting time point in the operating parameter curve;
determining a second time point corresponding to the ending time point in the operating parameter curve;
determining motion description information associated with the spindle motion mode; and
marking the motion description information in the operating parameter curve within a time interval composed of the first time point and the second time point.

6. The method according to claim 1, wherein the operating parameter curve comprises at least one of the following:
a vibration signal curve of spindle; power signal curve of spindle motor; a temperature signal curve of spindle motor; a power signal curve of servo motor; or a temperature signal curve of a servo motor.

7. The method according to claim 1, wherein the spindle motion mode comprises at least one of the following:
up-down motion; down-up motion; right-left motion; left-right motion; back-front motion; or front-back motion.

8. An apparatus for marking an operating parameter, the apparatus comprising:
a first module to acquire a three-dimensional image sequence about a spindle motion process of a machine tool, wherein the three-dimensional image sequence is captured by an imaging component;
a second module to acquire an operating parameter curve about the spindle motion process;
a recognizing module to recognize a spindle motion mode from the three-dimensional image sequence;
a determining module to determine time information of the spindle motion mode; and
a marking module to mark the operating parameter curve based on the time information and motion description information associated with the spindle motion mode.

9. The apparatus according to claim 8, wherein the recognizing module is configured:
to put the three-dimensional image sequence into a trained motion mode recognition model, trained to recognize the spindle motion mode in an artificial intelligence manner; and
to receive the spindle motion mode output from the motion mode recognition model.

10. The apparatus according to claim 8, wherein the recognizing module is configured to recognize the spindle motion mode from the three-dimensional image sequence using computer vision.

11. The apparatus according to claim 8, wherein the time information comprises a starting time point and an ending time point of the spindle motion mode.

12. The apparatus according to claim 8, wherein the marking module is configured to:
determine a first time point corresponding to the starting time point in the operating parameter curve;
determine a second time point corresponding to the ending time point in the operating parameter curve;
determine motion description information associated with the spindle motion mode; and
mark the motion description information in the operating parameter curve within a time interval composed of the first time point and the second time point.

13-15. (canceled)
